(19) United States
(12) Patent Application Publication
(10) Pub. No.: US 2004/0208222 A1
(43) Pub. Date: Oct. 21, 2004

(54) Vacuum chamber for induction heating and melting

(76) Inventors: Oleg S. Fishman, Maple Glen, PA (US); Maochang Cao, Westhampton, NJ (US)

Correspondence Address: PHILIP O. POST, INDEL, INC., PO BOX 157, RANCOCAS, NJ, 08073, US

(21) Appl. No.: 10/823,177

(22) Filed: Apr. 13, 2004

Related U.S. Application Data
(60) Provisional application No. 60/463,936, filed on Apr. 18, 2003.

(51) Int. Cl. F27D 7/06; F27D 23/04; H05B 6/22

(52) U.S. Cl. 373/141; 373/146; 373/157

(57) ABSTRACT

A vacuum chamber for induction heating and/or melting of a metal permits a significant portion of the magnetic field produced in the vacuum induction heating and/or melting process to make contact with the wall of the chamber without causing the chamber wall to overheat from induction heating.

### CROSS REFERENCE TO RELATED APPLICATIONS

This application claims the benefit of U.S. Provisional Application No. 60/463,936 filed Apr. 18, 2003, hereby incorporated herein by reference.

### FIELD OF THE INVENTION

The present invention relates to vacuum chambers for vacuum electromagnetic induction heating and melting applications.

### BACKGROUND OF THE INVENTION

Electromagnetic induction heating of various types of materials require that the induction heating or melting occur in a vacuum chamber or in a controlled environmental chamber wherein a specific gas atmosphere (such as nitrogen or argon) is maintained. FIG. 1(a) illustrates a typical prior art vacuum induction chamber 100 that can be used for a vacuum induction melting application. Crucible 102 can be used to contain the metal charge and melt 110 during the vacuum melting process. An arrangement of one or more induction coils 104 are wound around the outside of the crucible to induce a magnetic field that generates eddy current in the metal charge and melt for induction heating and melting when the one or more induction coils are connected to a suitable ac power supply. The useful portion of the generated magnetic field, illustrated by typical flux lines 106a (shown as dashed lines in the figures) penetrating into the crucible and into the metal charge and melt, is that which couples with the metal charge and melt to induce eddy currents in it. The non-beneficial portion of the generated magnetic field, illustrated by typical flux lines 106b (shown as dashed lines in the figures) not penetrating into the crucible, is that which does not couple with the metal charge and melt.

In other vacuum induction melting applications, crucible 102 may serve as an electrically conductive metal susceptor so that the useful portion of the magnetic field magnetically couples mainly with the susceptor rather than with a material placed within the crucible. A typical susceptor material is graphite, although molybdenum, silicon carbide, stainless steel and niobium may also used. By using a susceptor, non-magnetic materials placed in the crucible can be heated by transfer of magnetically induced heat in the susceptor. The susceptor may also be in other configurations, such as a disk, tube or a layer of material.

Since the induction melting process is being performed in a controlled environmental chamber, it is preferential to keep the chamber as small as possible. Further it is generally necessary to fabricate the chamber from a steel to achieve structural integrity under a vacuum environment. Since steel has a high electrical resistivity and often high magnetic permeability, any portion of the generated magnetic field that penetrates it will overheat the chamber and potentially cause structural deformation of the chamber.

Of course, the obvious solution would be to move the wall of the vacuum chamber back until a significant portion of the generated magnetic field, represented by typical flux lines 106b, did not penetrate it. However this would unnecessarily increase the size of the chamber which not only increases cost for the chamber material, but also increases the volume in which the controlled environment (i.e., vacuum or selected gas) has to be maintained. A more typical solution to this problem is to install electromagnetic shunts on the interior wall of the vacuum chamber for field concentration in the shunts and not in the wall of the chamber as illustrated in FIG. 1(b). Electromagnetic shunts 108 are as known in the art, namely a plurality of thin electrically insulated sheets composed from a high permeability material that are bundled together. In vacuum applications, CARLITE which is a silicon steel having an electrically insulative (glass) coating, is preferred. In non-vacuum applications the electromagnetic shunts may be attached directly around the outer perimeter of the one or more induction coils. However since in vacuum applications the crucible and induction coil combination are usually removably installed in the vacuum chamber, including the shunts in the crucible and coil assembly would add additional weight to the removable crucible assembly. A practical problem with the shunts is that the spaces between adjoining sheets are not air tight regions. Therefore drawing a vacuum in the chamber to a desired level requires drawing air from these spaces. Further certain induction melting processes result in the release of particulates. For example, if a graphite susceptor is used, graphite dust may find its way into these spaces and become potential contaminants for future induction melting processes. Therefore there is the need for a vacuum chamber for induction heating and melting applications that is compact in size and does not require the use of electromagnetic shunts in the vacuum chamber.

### BRIEF SUMMARY OF THE INVENTION

In one aspect, the present invention is an apparatus for and method of providing a chamber for induction heating and/or melting in a vacuum or controlled environment wherein the walls of the chamber will not be substantially heated by induction when a magnetic field used for the induction heating and/or melting process makes substantial contact with the wall of the chamber. Other aspects of the invention are set forth in this specification.

### BRIEF DESCRIPTION OF THE DRAWINGS

The figures, in conjunction with the specification and claims, illustrate one or more non-limiting modes of practicing the invention. The invention is not limited to the illustrated layout and content of the drawings.

FIG. 1(a) is a cross sectional view of a typical prior art vacuum chamber for induction heating and melting of a metal in the chamber without protective wall shunts.

FIG. 1(b) is a cross sectional view of a typical prior art vacuum chamber for induction heating and melting of a metal in the chamber with protective wall shunts.

FIG. 2 is a cross sectional view of one example of a vacuum chamber of the present invention for induction heating and/or melting of a metal in the chamber.

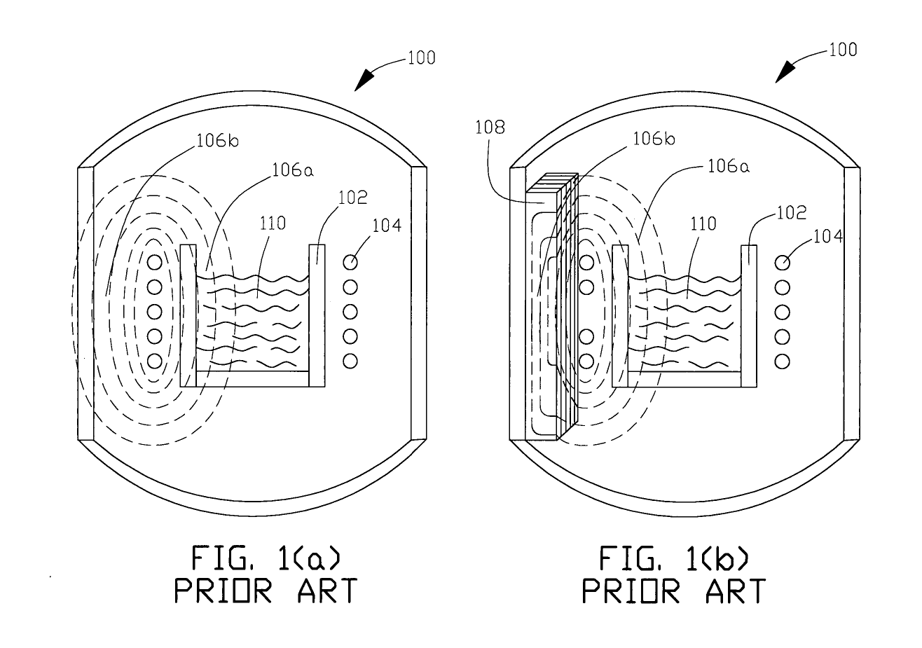

### DETAILED DESCRIPTION OF THE INVENTION

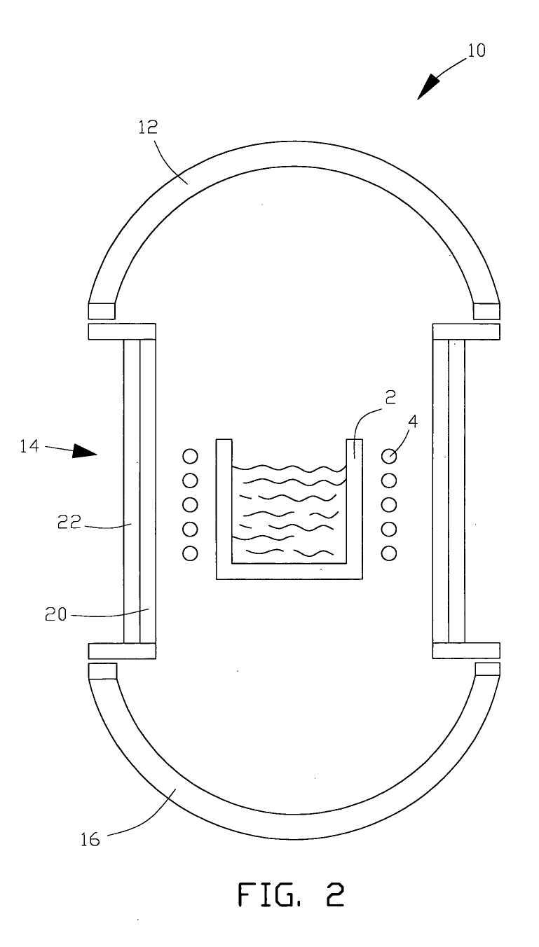

Referring now to the drawings, wherein like numerals indicate like elements, there is shown in FIG. 2 one example of the vacuum chamber 10 of the present invention. In this non-limiting example of the invention, the chamber comprises top portion 12, center portion 14 and bottom portion 16. Top portion 12 can serve as a removable lid for the insertion and removal of crucible 2. Bottom portion 16 can serve as the structural support element for crucible 2 and any other equipment provided in the chamber. Both the top and bottom portions can be formed from a stainless steel. One or more induction coils 4 surround the crucible and are supplied ac current from a suitable power supply (not shown in the drawing). AC current flowing through the coils generates an ac magnetic field that is magnetically coupled with either an electrically conductive material placed in the crucible, or the crucible, if it is a susceptor.

Center portion 14 comprises an at least two-layer structure wherein the inner layer 20 comprises a copper or copper composition material, and the outer layer 22 can comprise any material suitable for giving the center portion sufficient structural support.

The depth of induced eddy current penetration into any material is dependent upon the frequency of the induced eddy current, which is the frequency of the applied field, and the electrical conductivity and magnetic permeability of the material. More specifically the depth of induced eddy current penetration (δ) is given by the equation:

δ=503(ρ/μF)^{1/2}

where ρ is the electrical resistivity of the metal in Ωm; Ξ is the relative permeability of the metal; and F is the frequency of the induced eddy current resulting from the applied magnetic field when one or more induction coils 4 are supplied with current from a power source with an output frequency F.

The electrical resistivity of copper is low (nominally 1.673×10⁻⁸ Ωm), and its relative magnetic permeability is close to unity (non-magnetic material). Moreover, operating frequencies for vacuum operations are relatively low, typically ranging from 60 Hz to 10,000 Hz. Therefore from the above equation, one standard depth of penetration (i.e., the depth at which the eddy current density has decreased to 1/e (where e is Euler's constant, 2.718 . . . ) is very small.

If the thickness of copper that comprises inner layer 20 is at least equal to one standard depth of penetration, induced eddy current heating of the center portion 14 will be minimal when subjected to a significant portion of the magnetic field generated around one or more coils 4.

Outer layer 22 may be any suitable material for structural support of the chamber, such as an iron composition or a stainless steel.

The foregoing examples do not limit the scope of the disclosed invention. The scope of the disclosed invention is further set forth in the appended claims.

1. A vacuum chamber in which an induction furnace is disposed to inductively heat or melt an electrically conductive material placed within the crucible of the induction furnace by generating a magnetic field around an ac current carrying induction coil disposed around the exterior of the induction crucible and inside the vacuum chamber, the improvement comprising:
an at least a portion of the wall of the vacuum chamber penetrated by the magnetic field during operation of the induction furnace comprises an inner layer of a copper composition and an outer layer providing a means of structural support for the wall.

2. The vacuum chamber of claim 1 wherein the thickness of the inner layer is at least equal to one standard depth of penetration of eddy current induced from the penetration of the magnetic field.

3. A method of forming a vacuum chamber in which an electrically conductive material in the crucible of an induction furnace disposed within the vacuum chamber is inductively heated or melted by passing an ac current through an induction coil surrounding the exterior of the induction furnace and inside the vacuum chamber to generate a magnetic field that magnetically couples with the electrically conductive material, the method comprising the step of forming at least a portion of the wall of the vacuum chamber penetrated by the magnetic field during operation of the induction furnace from an inner layer of a copper composition and an outer layer providing a means of structural support for the wall.

4. The method of claim 3 further comprising the step of making the thickness of the inner layer at least equal to one standard depth of penetration of eddy current induced from the penetration of the magnetic field.

5. A vacuum chamber in which a susceptor is disposed to heat a material placed within the susceptor by generating a magnetic field around an ac current carrying induction coil disposed around the exterior of the susceptor and inside the vacuum chamber to inductively heat the susceptor, the improvement comprising:
an at least a portion of the wall of the vacuum chamber penetrated by the magnetic field during inductive heating of the susceptor comprises an inner layer of a copper composition and an outer layer providing a means of structural support for the wall.

6. The vacuum chamber of claim 5 wherein the thickness of the inner layer is at least equal to one standard depth of penetration of eddy current induced from the penetration of the magnetic field.

7. A method of forming a vacuum chamber in which a material placed within a susceptor is heated in the susceptor disposed within the vacuum chamber by the method comprising the steps of: inductively heating the susceptor by passing an ac current through an induction coil surrounding the exterior of the susceptor and inside the vacuum chamber to generate a magnetic field that magnetically couples with the susceptor; and forming at least a portion of the wall of the vacuum chamber penetrated by the magnetic field during inductive heating of the susceptor from an inner layer of a copper composition and an outer layer providing a means of structural support for the wall.

8. The method of claim 7 further comprising the step of making the thickness of the inner layer at least equal to one standard depth of penetration of eddy current induced from the penetration of the magnetic field.
